(19) United States
(12) Patent Application Publication
(10) Pub. No.: US 2025/0079965 A1
(43) Pub. Date: Mar. 6, 2025

(54) Electric vehicle drive mechanism for driving multiple alternators chain

(71) Applicant: Maurice Winslow Raynor, Los Angeles, CA (US)

(72) Inventor: Maurice Winslow Raynor, Los Angeles, CA (US)

(21) Appl. No.: 18/445,469

(22) Filed: Sep. 5, 2023

(51) Int. Cl. H02K 53/00

(52) U.S. Cl. CPC H02K 53/00; B60L 50/60

(57) ABSTRACT

An electric vehicle mechanism for driving multiple alternators chain comprises a plurality of alternators, an energy storage system, a gear, to a telescoping drive, the telescoping, square, shaft comprises the square shaft portions that extend along an axis of the vehicle. The mechanical energy than drives the telescoping drive's, rear, first, main sprocket, driving the first, main chain, rotating the second alternator's sprocket/rod, than secondary chain, rotating the alternator's sprocket/shaft, at that point forward or reverse would result in power production.

### TECHNICAL FIELD

The described embodiments relate generally to electric vehicle drive systems, and more Particularly, to a recharging system, said system KEEPS the Lithium ion batteries charged. Energy is created, ONLY, because of the vehicle's input, forward, or reverse movement.

### BACKGROUND INFORMATION

An electric vehicle drive mechanism for driving multiple alternators chain, includes a Lithium ion battery storage system that stores electric energy. In this example, the energy storage system comprises a plurality of thirty three Lithium ion batteries. The electric vehicle converts the electric energy stored in the battery packs into mechanical energy used to drive the electric vehicle forward. The electric vehicle's RANGE OR DISTANCE IS UNKNOWN. Regeneration of the battery pack is performed by ROTATION OF THE SYSTEM′S THIRTY THREE ALTERNATORS, this function is the same as any regular alternator, to battery relationship. As the energy in the battery pack is depleted, THE SYSTEM STARTS THE ALTERNATOR TO BATTERY, ENERGY PRODUCTION RELATIONSHIP, when forward, or reverse motion takes place. The system is mimicking a car engine's function as it relates to battery charging. With todays technology, this charging function requires that the battery pack be charged at a charging station, for a lengthy period of time. Also finding a charging station can be a problem. Another technique utilized for charging battery packs when in operation, as it relates to a electric car, is to employ different methods. Like solar panels witch are disposed along the outer surface of the electric vehicle. When exposed to the sun light, with this method, regeneration of the electric vehicle takes place.

The one drawback to this system, is the unavailability of sun light or at low light instance during the day, or operation of the electric vehicle at night. Not regenerating the battery pack, or just a slight charge. A more robust solution to achieve regeneration is needed. In that effort to achieve a more efficient charging technique, the brake regeneration system, (HAVING NOTHING TO DO WITH THIS INVENTION) charges your depleted batteries when the brakes are applied. Thereby gaining extended performance, as it relates to battery pack regeneration. The brake regeneration system would SLOW DOWN<OR STOP MY INVENTION.

### BRIEF DESCRIPTION OF THE DRAWINGS

The drawings submitted for review in all cases, illustrate conformity of number to components, illustrate embodiment of the invention.

FIG. 1 is a diagram of a telescoping mechanism that allows a physical attachment, from the drive wheel, to the body of the platform. Taking in to account all the movement made by a tire on it's road travels. Between plates 13, and 14 A main drive point/connection two, by way of a inner, square, independent, fit, lock. Below, left of center, of the frame, the third, main, drive point in the system. A sprocket 19, rotates chain 20, rotates the alternator's sprocket/rod. The rear, drive shaft housing is braced in two different directions 15 A, 15 B. The system sealed in a flexible, rubber, conical like, boot, all bearings made mobile by way of lubrication/grease. The system is secured to the frame, and can be adjusted. The outer, housing support system “piggy backs on the stock brake bolts, extended 3 A.

FIG. 2 is a diagram of a front perspective of the telescoping drive, reverse, flat top, pyramid like support base stopping any forward, or backward movement. In addition supported by a secondary, reverse, flat top, pyramid like support 4-Q 16, with this perspective, two are visible 13, 14 A. Having the telescoping, square, drive central to a group of bearings, affording smooth rotation of said telescoping, square, drive 11 A, 11 B, 11 C, 11 D, 11 E, anchored at it's highest point with four adjustable bolts, and nuts.

FIG. 3 is a diagram of a over head perspective of the alternators front, end configuration. Reconfiguring a over head, to side perspective, exposing all ten front alternators, and their alternator's electric, designations. All rotated by the rubber, drive wheel 1, rotating the disk/gear 2, than rotating the square, telescoping, drive, on to the sprocket rotating the chain, rotating the alternator's sprocket/rod, and alternator's chain, than finally the alternator's sprocket/drive shaft. Having a center, sprocket/rod, bearing support 32, 31 A, 31 B, 31 C.

FIG. 4 is a diagram of a front perspective of a two alternator bracket/plate 26, and sound/vibration reduction chain cover. In addition above, is a two alternator bracket/plate, illustrating two alternators configured on the other side of said bracket/plate, and their holes attachment system. Having a attachment strip 43.

FIG. 5 is a over head perspective of the front, center, sprocket/rod, support system, having a rectangular like, top, front, support base 28. The apparatus receiving a rod, from both sides. affording smooth rotation of the rod, by way of ball bearings, and greasing with a greasing nipple 45 G. A group of forward, center, dotted lines illustrates the support post position 40, the post fixed in place with nut 28, 41, 32.

FIG. 6 is a diagram of the back portion of the center, sprocket/rod support. Having a vertical support post, anchored to the platform floor 40, and lower bearing housing support 48.

FIG. 7 is a diagram of a two sized, sprockets 19, and 31 A, fixed to a rod 32, rotated smoothly by a group of bearings at each extremity, lubricated with grease, by way of a grease nipple. The larger sprocket is the main drive, the smaller sprocket/chain are secondary 6, 45 G.

FIG. 8 is a diagram of a side perspective of a complete charging system, having a rubber, drive Wheel, transferring mechanical energy to the square, telescoping, drive 1, 11 A, 11 B, 11 C, 11 D, and 11 E. That system rotates the main, rear sprocket 19, than the main chain 20, rotating the alternator's sprocket/rod, rotating the alternator's sprocket/drive shaft 31 A, generating energy to supply to each of the thirty three Lithium ion batteries. Having the batteries configured to the rear, lower portion of the platform. Wherein the thirty third Lithium ion battery serves to supply energy to all functions of the platform 25, EXCEPT the energy consumed by the motor, the alternators/Lithium ion batteries creating energy by means of mechanical energy, derived from the rubber, drive wheels forward motion, will replenish consumed energy from the motor 1, 39. On the upper portion of the diagram, is illustrating a sound/vibration, reduction chain guard 1, 20, 31 A, 31 B.

FIG. 9 is a diagram of a side perspective of a four alternator bracket/plate 50, having alternators configured on the other side of said bracket/plate 50. In addition a sound/vibration, reduction, chain guard is illustrated, exposing the alternator's control holes on the bracket/plate 27 B. Two, four alternator brackets/plates, configured to the far left, and far right of the rear alternator platform configuration.

FIG. 10 is a diagram of a side perspective of alternators, and rear alternators configuration, positioned to the rear, ¾ length back from the front bumper on the platform, having a main sprocket chain driving system on both sides of the platform 17, 18, and 19. Said sprocket/chain rotates the secondary sprocket/rod, thereby rotates the alternator's sprocket, and shaft, energy is produced 31 A.

FIG. 11 is a diagram of a identical, side/rear perspective of FIG. 10, illustrating the individual alternator's electric designations, thereby matching it's battery alternator's electrical designations, thereby matching it's battery energy retention system, the Lithium ion batteries 53,54.

FIG. 12 is a diagram of left side perspective of a dual, rear sprocket/rod, bearings, center, end, supports system 60 A, and 60 B. Braced with three angle braces, having a upper bearing housing configuration 6, 44. Lubricated with a rubber layer 56 A, bolted down to the platform floor.

FIG. 13 is a diagram of a rear perspective of FIG. 12, illustrating the bearing housing, receiving the rod, having one forward, and two rear braces. Supported centrally, bolted in place, while being protected by a rubber insulation layer.

FIG. 14 is a diagram of a over head perspective of a electrical schematic/configuration of Lithium ion batteries power lines, leading to a secondary/major fuse brake 67, having cleared, the brake, traveling on a high voltage line, it's destination is the “ON, OFF, ACC, and LOCK” switch system 69. Than in the ON position, as it relates to the switch, transfers the energy of thirty two fully charged Lithium ion batteries to the motor. The motor receives that power by way of a motor receiving unit 67, 70, 79.

FIG. 15 is a diagram of a side perspective of a 12 V, 120 VAC, individual battery charger 72, having a male rod like positive 12 V 75 configured to connect with a female receiver 12 V line, directed to a specific Lithium ion battery. A low voltage light 77, will have that Lithium ion battery be addressed for recharging. Battery 1 B, to 33 B will be represented on the recharge/light, panel 78.

FIG. 16 is a diagram of a front perspective of the alternator 1 A, feeding power to the individual charger 72, on power line 1. Triggering the low voltage light, the low voltage detector 80. 1 B having power of the thirty two Lithium ion batteries are illustrated, for the motor's use, the thirty third Lithium ion battery serves all platform's functions, except the motor. All electrical systems are grounded to the platform.

FIG. 18 is a diagram of a side perspective o a platform's air cooling system, having a door air receiver, or not apparatus 83, guiding the air through the added door vent system 82, to the opening on the inside of the car door jam 84, transferred through the front portion of the rear, side, panel post 85, forcing air through the rear opening 86, over the alternators, as well as the Lithium ion batteries.

### DETAILED DESCRIPTION

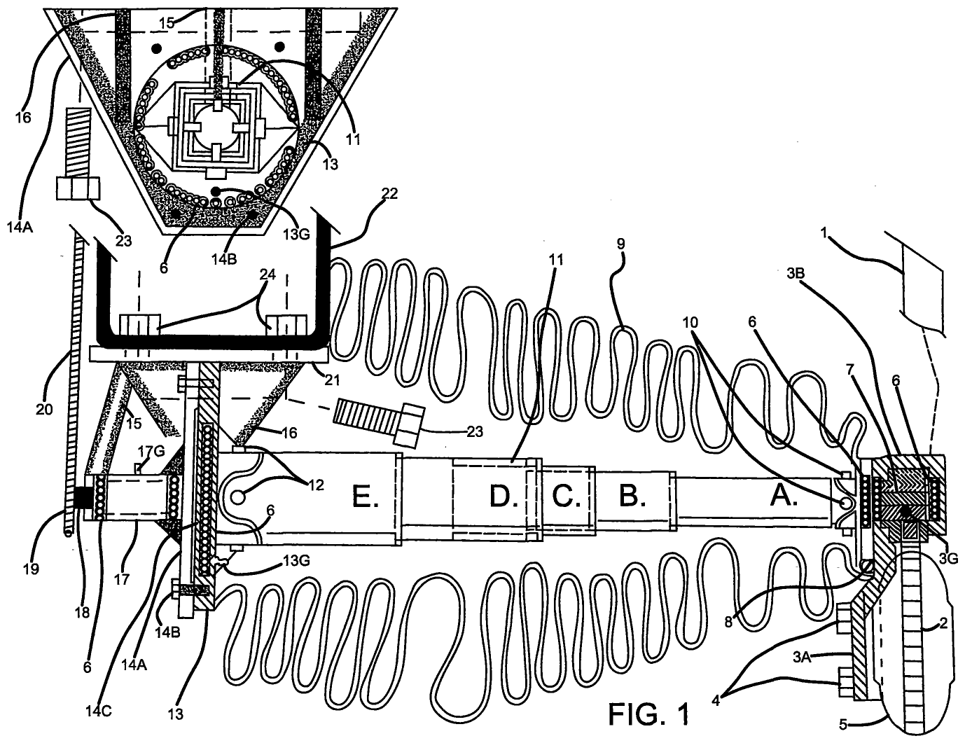

FIG. 1 is a diagram of a side perspective of the system's drive connection, as it relates to the wheel drive 1, to the platform's body 25. Having five, square, telescoping, uniformly larger at the inner, near, proximity to the platform's body 11 A, 11 B, 11 C, 11 D, and 11 E. In addition having immediately to the drive housing, a disk/drive gear, machined 2, configured to have teeth, to accommodate a drive connection, with the drive, rubber, wheel 1. Configured to be supported at it's base 3 A, “piggybacked” on the brake support system, the drive housing 3 B having two sets of bearings 6, as well as the smaller, outer, universal joint 10, is also made mobile, as it relates to rotation by way of bearings and lubrication 3 G. All internal components kept dirt/moisture free with a flexible, rubber, boot 9. At near proximity to the platform's body 25, the largest universal joint 12, having a reverse, flat top, pyramid like base support 13, and 14 A, and bearing housing so as to rotate the telescoping drive at the body. Also having smooth rotation with lubrication. Both of the reverse, flat top, pyramid like support systems are configured to a adjustable, slide, top plate 21, fitted to be fixed to the platform's body frame 22. After a chain 20 adjustment, a stable anchor is achieved with four locking bolts/nuts system 23, 24, stopping any forward, or reverser movement. Rotating at the farthest point from the drive wheel, the inner shaft 18, the telescoping drive's rear, shaft/bearing housing 17, braced on a vertical angle 15 A. In addition braced in a forward, horizontal; angle, to the Side of the rear, drive shaft, having a direct connection to the inner, drive shaft 12 the drive Sprocket and chain 19, and 20, also rotate by bearings, and lubrication takes place by way of a Greasing nipple 17 G. The chain 20 rotates a group of alternators.

FIG. 2 is a diagram of a front perspective of FIG. 1 illustrating the uniform reduction, in size of the five, square, telescoping, drive components 11 A, 11 B, 11 C, 11 D, and 11 E. Having angular, brace, support for the larger, inner, universal joint component. The telescoping drive is supported, and prevented from any forward, or backward movement, by way of the reverse, flat top, pyramid like support 13, and 14 A, housing a group of bearings 6 in the forward, reverse, flat top pyramid like, telescoping drive support base. The adjustable, top, plate 21 is fixed in place with four, upper bolts/nuts 23, and 24.

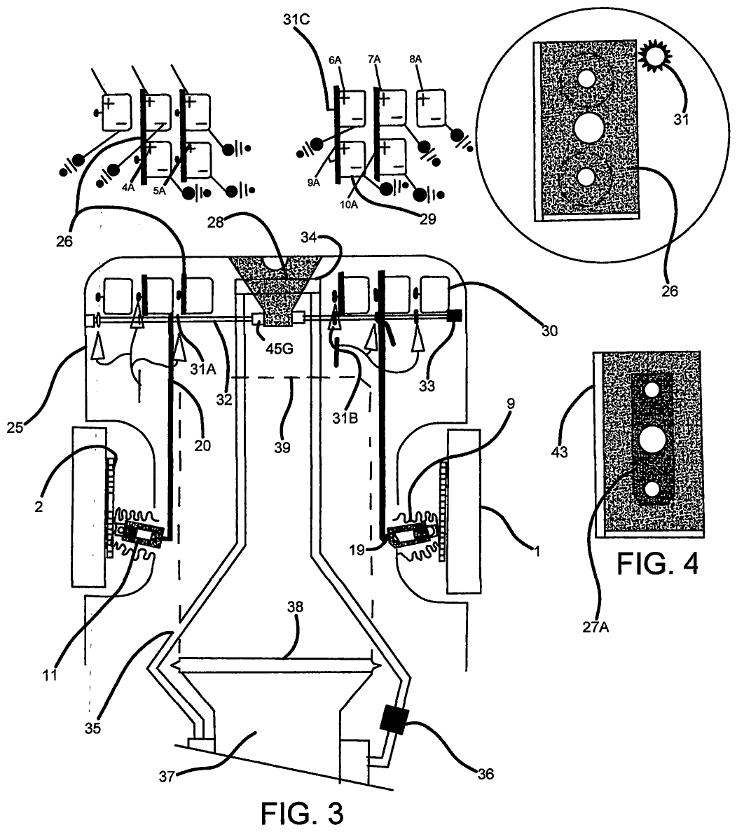

FIG. 3 is a diagram of a top perspective of the platform's forward, drive, rubber, wheels, with telescoping drive, affording rotation of the drive chain 20. A ten forward configuration, and over head configuration of the forward alternators 29, and 30, is illustrated. All alternators centrally supported with a center support system 28. A transmission cooling radiator 34, and lines 28, 35 configured to cool the transmission 37. The ten alternators are attached by way of motor cycle chain 20, to the designations of the alternator's sprocket rod 31 A, 32. The rods having center/end bearings, kept lubricated by way of grease, and a grease nipple 45 G. The forward alternators total number is ten 29, 30, five per rubber, drive wheel 1.

FIG. 4 is a diagram of a front perspective of a two alternator support brackets/plates 26. The lower bracket/plate illustrates a sound/vibration reduction, chain guard/cover 27 A, having a forward, and lower anchor strip 43 on said bracket/plate, with attachment bolts holes, in addition having adjustment, slide, bolt holes. The upper two alternator support bracket/plate 26 illustrates the alternator's positioning on the other side of the bracket/plate. With attachment holes, in addition to adjustable, slide holes. The sprocket 31 is illustrated as it is positioned in relationship to the alternators bracket/plate. The brackets/plates having a forward, and lower anchor strip 43.

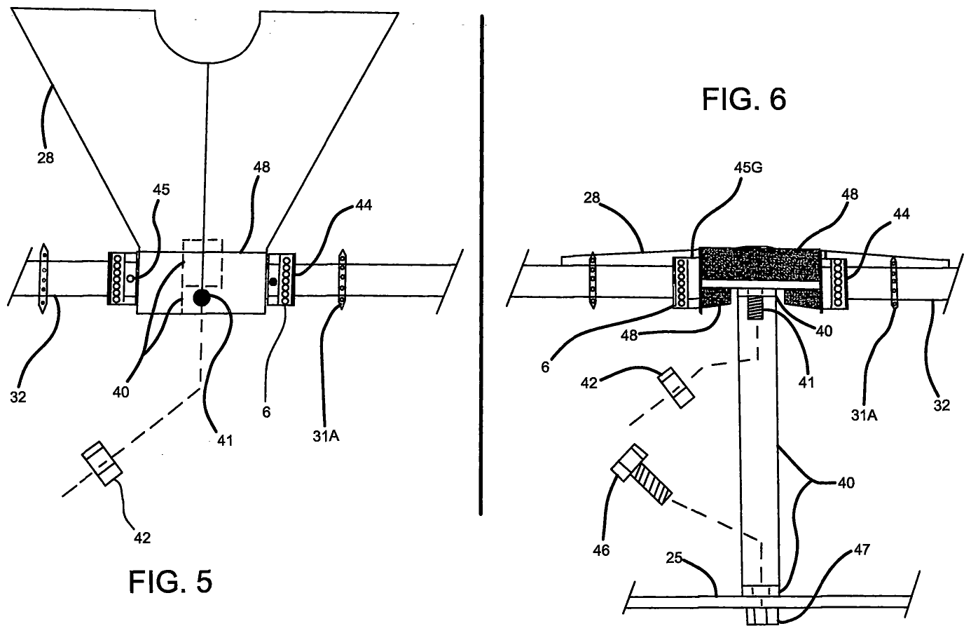

FIG. 5 is a diagram of a over head perspective of a center, end bearing, support system. Having alternator's sprockets/rods 31 A, 32. Rotated smoothly by way of bearings 6, and lubrication system 45 G. Having a center support post 40, fixed to the platform with a locking nut 42, also having a fixed in place bolt.

FIG. 6 is a diagram of a rear perspective of FIG. 5, having a clear view of the post 40 configuration, anchored at it's highest point, with a set in place bolt, 41, fixed in place with a nut 32. Inclusive of a anchor to the platform's floor 46, 47. In addition illustrating the lower bearing housing support 48, at either side of the upper portion of the center support post 40. Having the sprockets/rods 31, 32, supported, affording smooth rotation of the sprockets/rods. Lubrication of all bearings take place by way of the greasing nipple 45 G.

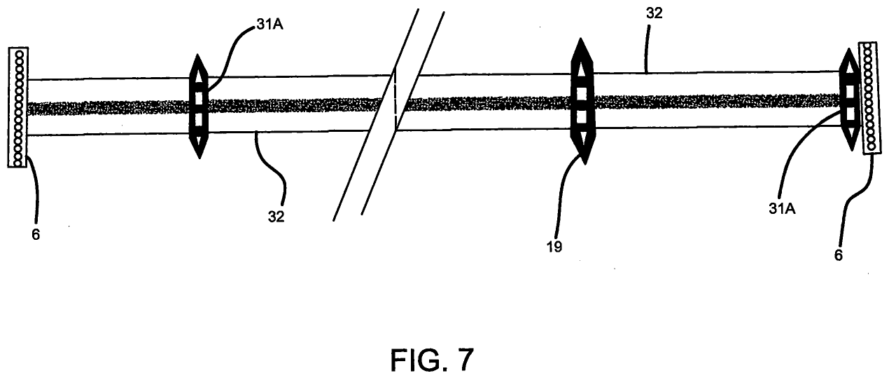

FIG. 7 is a diagram of a over head perspective of a two size, chain, sprocket, first sprocket 19, and second sprocket 31 A. Configured on a rod 32, having bearings 6 at either end of said rod. The larger chain/sprocket 29, 19 is configured to rotate the smaller, sprocket/chain 31 A and 31 B configuration, thereby rotating the alternators. The bearings are kept lubricated with grease, by way of a greasing nipple 45 G.

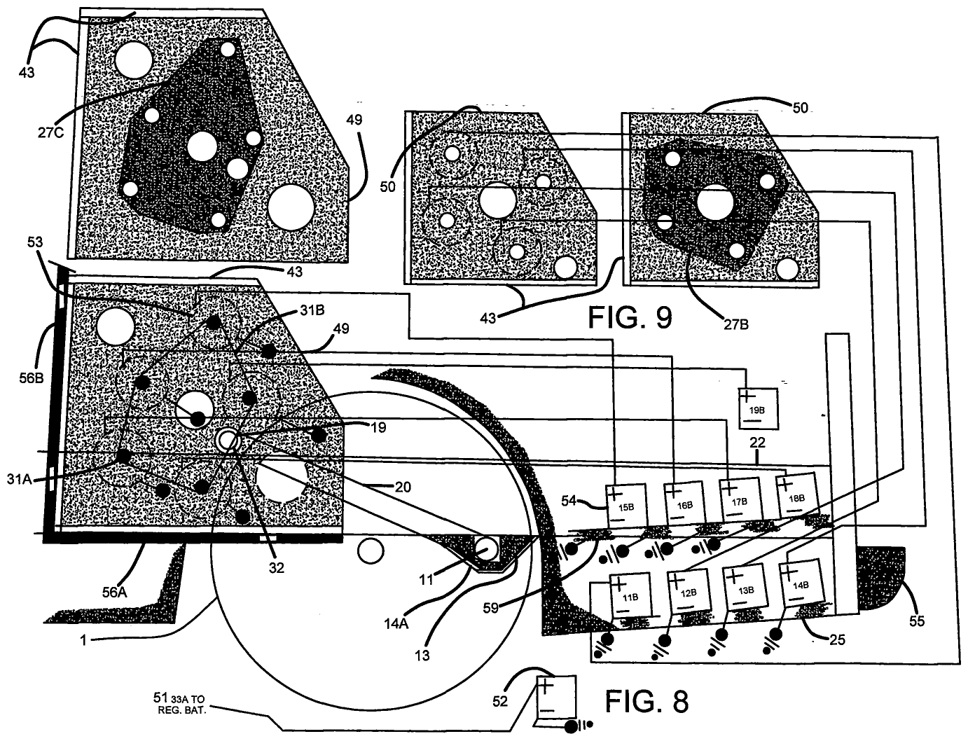

FIG. 8 is a diagram of a side perspective of a complete regeneration system to the rear of the platform, having a five alternator holding bracket/plate system 49, wherein rubber, sound/vibration material is employed 56 A, 56 B. Having a rubber, drive wheel 1, that must be rotated by forward motion of the platform 25, thereby rotating the five part, square, telescoping, drive system 11 A, 11 B, 11 C, 11 D, and 11 E. Mechanical energy is transferred to Lithium ion batteries 1 B, to 33 B, configured to the rear of the platform 25. The regular 12 VOLT car battery functions, other than motor service, is performed by alternator 33 B, charged by 33 A. A sound/vibration reduction chain cover 27 C is illustrated for the five alternator bracket/plate system, with attachment strips 43.

FIG. 9 is a diagram of a side perspective of a set of two, four, brackets/plates alternator support systems 50, the left bracket/plate illustrating alternators configuration on the other side of the bracket/plate. In addition to 11 B, 12 B, 13 B, and 14 B are being charged, by the same manner as the five, FIG. 8 alternators. The right bracket/plate 50 illustrates the sound/vibration, chain cover's 27 B configuration, on the bracket/plate, as it relates to the alternators on the other side of the bracket/plate. Round voids in the brackets/plates accommodates sprockets/rods, as well as alternator's drive shafts.

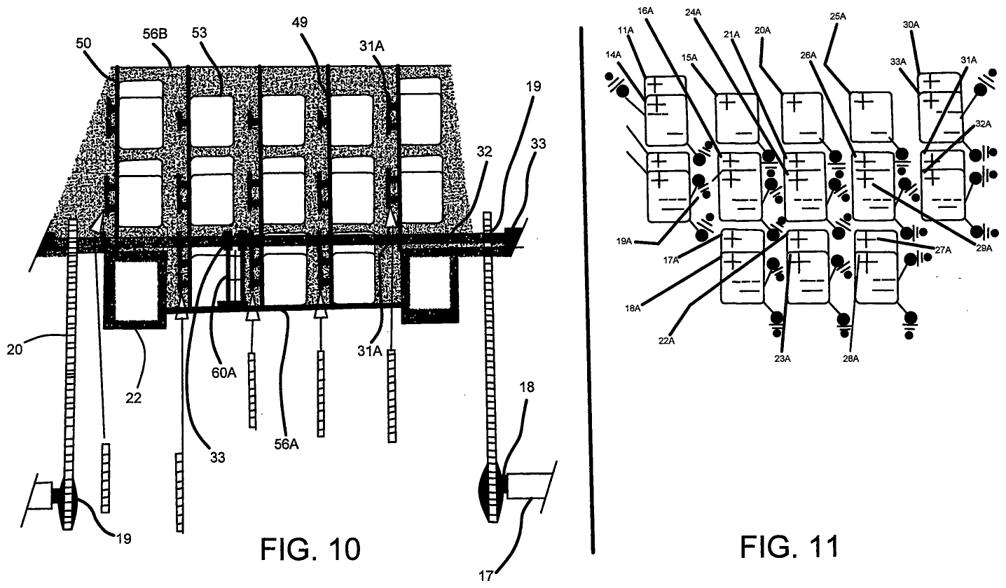

FIG. 10 is a diagram of a rear/side perspective of a group of twenty three alternators. Configured in this order, from left to right, four bracket/plate, five bracket/plate, five bracket/plate, five bracket/plate, and lastly, a four bracket/plate 50, 49, 49, 49, 50 support system, affording said twenty three alternators stability, with smooth rotation. The relationship of sprockets chains 19, and 20, as it relates to the alternator's sprocket/rod 31 A, and 31 B are Illustrated, having a physical connection to one another through the chain 20, thereby rotating chain 31 B. Rubber sound/vibration reduction material 56 A is employed on the platform's floor. The two extension on both sides, lower, are a part of the telescoping mechanism, drive system 17, 18, 19, and 20. The smaller size sprockets/chains are illustrated 31 A, 31 B.

FIG. 11 is a diagram of a identical, rear/side perspective od FIG. 10, illustrating the individual alternator's electrical designations, thereby matching each Lithium ion battery, in the energy retention system, with it's alternator.

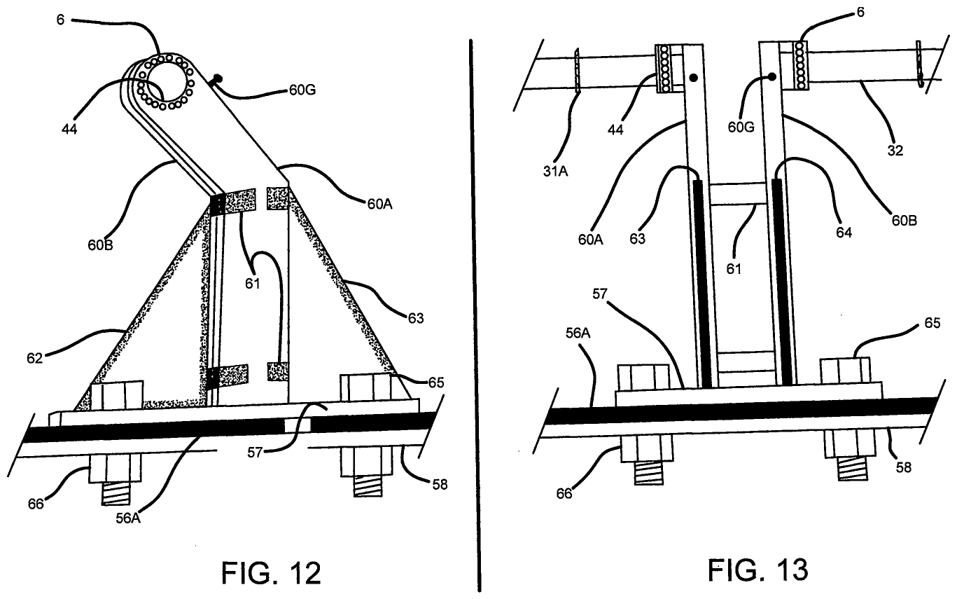

FIG. 12 is a diagram of a left, side perspective of a dual, support system 60 A, having a sole, right, front, angle support brace 62, as well as two rear angle support braces 63, affording forward, to reverse stability. All anchored to a base plate 57. A rubber sound/vibration reduction material 56 A, is set between the apparatus's base, and the platform's floor 58. Said base configured to be anchored to the platform by four bolts/nuts 65, 66, stability is increased with four horizontal braces 61 two in front, and two in the rear of the vertical body, of this Apparatus. The bearing housing and seal is at the upper most part of this apparatus 6, 44.

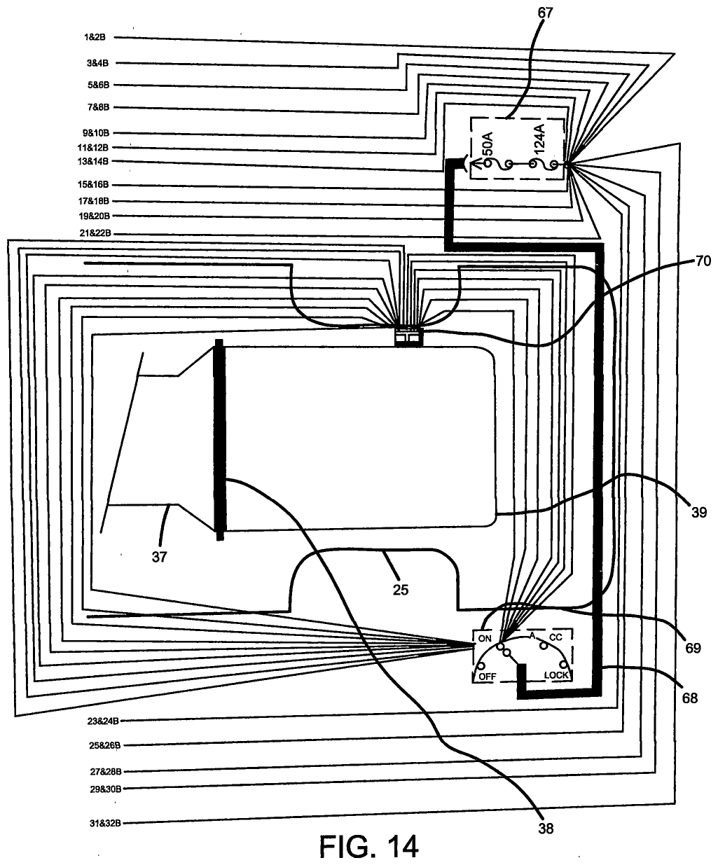

FIG. 13 is a diagram of a rear perspective of FIG. 12 exposing the distance between vertical bodies 60 A and 60 B. Having the two, rear vertical, angle braces 63, 64, in line with the apparatus's vertical body. In addition illustrating four corner bolt/nut attachments. The \bearing housing clearly apparent, as it relates to the sprocket/rod, the rod insertion into the bearing housing. All lubricated by grease, by way of a grease nipple 60 G. FIG. 14 is a diagram of a over head perspective of a electrical schematic/diagram, receiving power from thirty two Lithium ion batteries to a fuse brake, a high voltage line, than controlled by way of a “OFF, ON, ACC, LOCK system 69. Having energy delivered from the alternator system, to the battery system, than finally to the system controlling energy to the motor 70. Protected by a fuse brake 67, before the control system 69, on to the motor receiving unit. In addition the motor, transmission configurations are illustrated 39, 37.

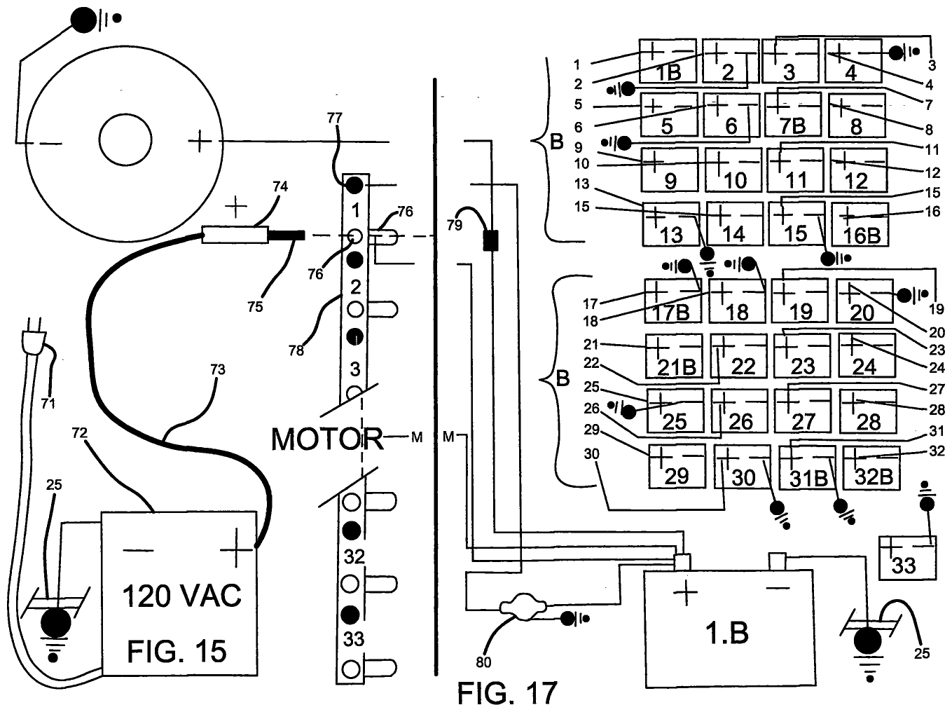

FIG. 15 is a diagram of a side perspective of a (nail like) rod 75, individual, 12 V A C charger, charging system 72, having a low voltage light/charge panel 78, 77, 76, to address low voltage NOT due to the motor's energy consumption, that will be replenished. Other reasons, such as damaged alternator/s, or damaged Lithium ion battery/s, charging will be necessary with that low/no voltage, that is a individual battery charging situations.

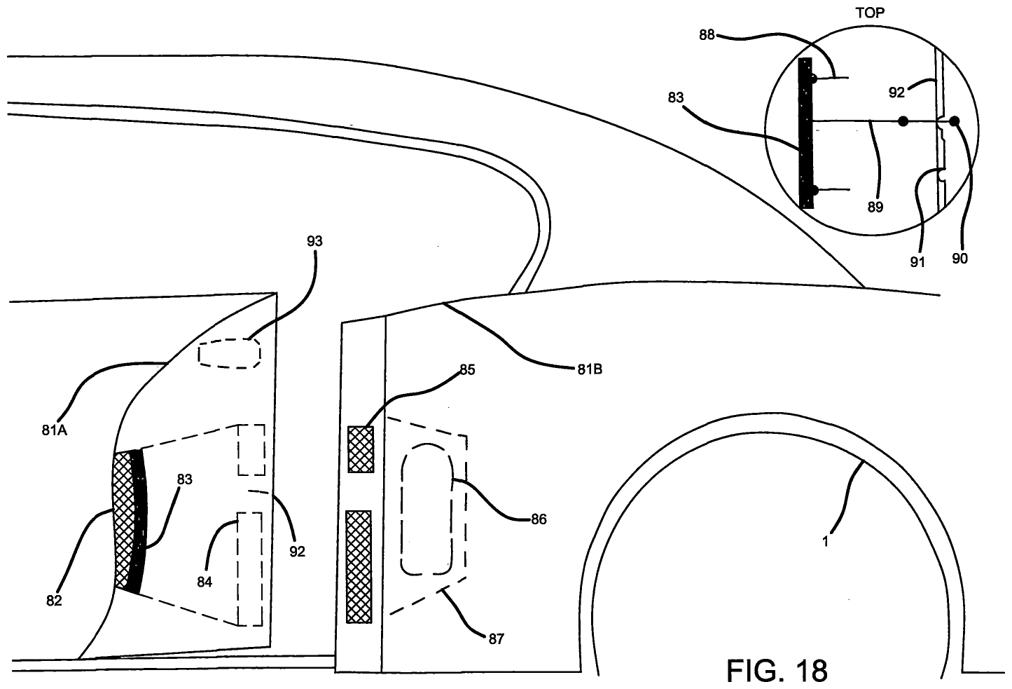

FIG. 16 is a diagram of a front perspective of a alternator 1 A, charging line 1 leading to a 1 line, where Lithium ion batteries are being charged. NO OTHER FORM OF ENERGY PRODUCTION APPLIES.

FIG. 17 is a diagram of a side perspective of a Lithium ion battery 1 B. receiving energy from the alternator 1 A. In addition a line 1 connection from the 12 V charger 72, IF NEEDED, Is Illustrated. Keeping the batteries charged, the low voltage apparatus allows a individual charge to any battery that triggers the low voltage light 17. To the rear of the platform is configured thirty two Lithium ion batteries, with a single 12 V battery 33 B, for the car's non motor function. Batteries all grounded to the platform.

FIG. 18 is a diagram of the alternator/battery, door/side panel air cooling vent system, having a door, outer surface vent attachment 81 A, and a rear, back panel, further out from the surface of the stock surface 81 B, to start directing the air in a from more forward position, hence use the door for sooner excess to the air. The air is captured at the most forward vent 82, travels through the door's outer surface, vents, out the inner door casing/jam vents 85, trapped in a air director 87, air is forced into cooling excess hole 86, affording air flow over the alternators air first, than air flows over the Lithium ion batteries at the rear, lower floor of the platform, the air exiting out through the rear exit vent openings. This is the only cooling system.

### NUMERICAL IDENTIFICATION OF ALL DRAWING COMPONENTS

1-33 (A) Will represent the first in line, for energy reproduction components, the alternators.
1-33 (B) Will represent the second in line, for energy reproduction/storage components the Lithium ion batteries.
1. Standard tire.
2. Brake disk, machined, to have teeth.
3 A. mounting bracket, piggybacked on the stock, brake attachment. With the need for two longer bolts.
3 B. upper, housing.
3 G. grease nipple.
4. Bolt #1, 2-Q.
5. A stock brake system.
6. Bearings.
7. Inner, housing, drive gear.
8. Flex, rubber boot, clamp, with screw.
9. Flexible, rubber, telescoping drive, seal, boot.
10. Smaller, front, universal joint.
11. A five part, telescopic, square, drive.
11 A. Smaller, outer most, attached to the smallest universal joint, component.
11 B. Next in line, progressing in ward, the second component.
11 C. Next in line, progressing inward, the third component.
11 D. Next in line, progressing again inward, the fourth component.
11 E. Last in line, the largest component, attached to the largest universal joint, the fifth component.
12. Larger, rear, inner, universal joint.
13A. Reverse, flat top, pyramid like, first, forward, telescopic support, bearing housing, forward, To reverse brace.
13G. Greasing nipple.
14A. Additional secondary, rear, telescoping drive, rear support, for the first in line sprocket/chain general configuration, as the forward most support apparatus.
14B. A group of twelve retention/holding bolts.
14C. Inner, adjacent to the bearing, rubber, gasket.
15A. Rear, drive shaft, housing, angle brace, more vertical than the forward facing angle brace.
15B. Forward facing angle brace for rear, drive shaft housing.
16. A group of four, triangle like, both sided, braces, for side to side rigidity.
17. Rear most, first in line sprocket drive shaft housing.
17G. Greasing nipple.
18. Rear most, first in line, sprocket, drive shaft.
19. First in line, main motor cycle sprocket.
20. Motor cycle chain, first in line.
21. Back and forth, top, slide plate, to tighten the chains.
22. platform frame.
23. Bolt #2, 2-Q.
24. Nut #2, 2-Q.
25. The outer edge of the vehicle platform.
26. Two alternator holding bracket.
27A. Two alternators, sound/vibration, reduction, chain cover.
27B. Four alternators, sound/vibration, reduction, chain cover.
27C. Five alternators, sound/vibration, reduction, chain cover.
28. Center, alternator's sprocket/rod, bearing, system support.
29. #9A alternator.
30. #8A alternator.
31A. Second in line, motor cycle sprocket, for the rods and alternators only.
31B. Second in line motor cycle chain.
31C. Alternator sprocket.
32. Rod.
33. End bearings.
34. Small, standard, transmission radiator.
35. Transmission fluid lines.
36. Transmission fluid pump.
37 Standard transmission.
38. Electric motor, to standard transmission junction apparatus.
39. Electric motor drive.
40. Vertical post.
41. Bolt #3, 1-Q.
42. Nut #3, 1-Q.
43. Bottom, side, top, attachment strips, configured to secure all racks/plates to the platform.
44. Bearing housing seal.
45G. Greasing nipple.
46. Bolt #4, 1-Q.
47. Nut #4, 1-Q.
48. Upper and lower bearing, housing, support.
49. Five alternators, holding, bracket, stationary, rotisserie like configuration.
73. 12 V, power, delivery, charge line.
74. Charge post handle.
75. 12 V, male, elongated, rod power delivery apparatus.
76. Female, tube like, 12 V power receiving apparatus.
77. Low, voltage level, red indicator light.
78. The charging/low voltage indicator light panel.
79. First fuse brake, for alternator to battery.
80. No/low voltage detector.
81A. A added steel, door, air scoop.
81B. Rear, panel, addition air system.
82. Forward, rear, door, vent.
83. Forward, rear, door vent, rain/moisture, stop, door.
84. Rear, rear, door casing, vents.
85. Rear, panel; door, jam, vents.
86. Rear, air access, hole.
87. Air director.
88. Door closing springs.
89. Small, chain, door closing apparatus.
90. Ball, door, opening locks, closing apparatus.
91. Lower ball stay.
92. Inner, door side, jam/wall.
93. Remove rear, door latch/handle, and replace it with electric door latch control.

The invention claimed is:

1. An electric vehicle drive mechanism for driving multiple alternators chain comprising:
a front gear mechanism that is coupled to a wheel of the electric vehicle;
a second gear mechanism;
a square, telescoping shaft having a first end and a second end, wherein the square, telescoping, shaft extends along a first axis;
a first universal joint, wherein the first universal joint is disposed at the first end of the square, telescoping, shaft, in addition wherein the first universal joint couples the first end of the square, telescoping, shaft to the second gear mechanism;
a second universal joint, wherein the second universal joint is disposed at the second end of the squared, inner, housing, locking mechanism;
a double, reversed, flat top, pyramid, like base/housing, bearing, support wherein it is fixed with adjustability to the platform frame, having front to back stability;
a group of four components, triangular in configuration, upper, angle braces wherein two are visible, one at a 60 degree angle, with one unseen, and one at a 130 degree angle with one unseen;
a upper, adjustable base, plate wherein it is supporting all components beneath it;
a bolt/nut attachment system;
a rear, angle single, base 15 A, wherein it's fixed centrally to the upper support plate's outer edge, configured on a 70 degree angle to a lower support point disposed at the front of the sprocket, shaft housing;
a rear, angle, single, forward facing brace wherein the brace supports the stress from the first inline chain 15 B, 20;
a rear, bearing/shaft housing wherein it is configured to rotate the main sprocket/chain;
a main sprocket/chain wherein a base for alternator's rotation, is configured to the rear, or inner portion of the square telescoping drive system;
a rubber, gasket, wherein it is a sealing component 14 C, 23, 24.

2. The electric vehicle drive mechanism for driving multiple alternators chain of claim 1., wherein the diagram is a front perspective of FIG. 1 having a front, triangle like base/support for the square, telescoping, drive system comprises:
a rear, triangle like brace/support, wherein that support further anchors the forward, triangle like brace/support, by way of twelve anchor bolts, to it's self, and the over head plate;
a group of two angle braces, one 60 at degree, and another at 130 degree wherein they are exposed, disposed to the upper 60% of the forward brace/support, (also the rear second brace/support, is unseen), from the rear;
a center, rear, angle brace wherein said brace is fixed to the upper plate, supporting the rear, lower, drive shaft, bearing housing;
a forward, bolt wherein it's configured to anchor to the fixed, with nuts, over head, diagram;
a front perspective of the five part, telescoping drive wherein mechanical energy is transferred to the body of the platform;
a bearing configuration wherein the bearings are disposed to in circle the five part telescoping drive;
a greasing nipple wherein it affords smooth rotation of said telescoping drive.

3. The electric vehicle drive mechanism for driving multiple alternators chain of claims 1, and 2, wherein the front, two telescoping drives, in addition to the front ten alternator's configuration is illustrated comprises:
a dual, front tire drive, wherein mechanical energy is directed to the two telescoping drives;
a main sprocket/chain, wherein that system is configured to rotate the secondary alternator's sprocket alternator's sprocket/chain system, the main sprocket and main alternator's sprocket, on the alternator's sprocket/rod, are on the same axis, having a mobile, physical attachment;
a over head perspective of a two grouping of alternators wherein they are configured to the front of the platform;
a alternator's sprocket/rod wherein rotation of the alternator's drive shaft takes place;
a center support apparatus wherein the sprocket/rod is supported, for the alternator's system;
a side perspective of two, five groupings wherein a indication of their electric designations takes place.

4. The electric vehicle drive mechanism for driving multiple alternators chain of claim 3, wherein the two alternator bracket/plate comprises:
a two alternator brace/plate wherein it is illustrating a anchor/adjustment bolt holes for the alternator's fix in place apparatus;
a chain guard wherein sound/vibration is reduced;
a bracket/plate wherein there are two alternators on the opposite side of the bracket/plate, configured to be rotated;
a side, as well as lower bolting flange wherein it is configured for a safe anchor, with bolts'

5. The electric vehicle drive mechanism for driving multiple alternators chain of claim 3, wherein the front of the platform comprises:
a group of ten, forward alternators are rotated by a sprocket/rod system, wherein said system is supported to rotate the ten alternators by a forward, center, alternator's sprocket/rod bearing, housing support system;
a vertical post (unseen) wherein alternator's sprocket/rod, center, support is self supported at it's more rear portion, as it relates to the front bumper;
a triangular like front attachment, wherein a anchor to the forward, upper portion of the platform and the most forward part of the bearing housing support system, is required;
a upper nut, wherein the upper portion of the bearing housing is locked into place.

6. The electric vehicle drive mechanism for driving multiple alternators chain of claim 5, wherein this diagram is a lower, rear, perspective of FIG. 5, bearing housing support system comprises:
a exposed lower bearing housing support, for both sides of the system, wherein the system is afforded a rear, center, support;
a lower bolt/nut is fixed with no possible movement, to the platform's floor;
a center, triangular, like support, wherein the support's relationship with the bearing housing support, is center of both sides of the bearing housing.

7. The electric vehicle drive mechanism for driving multiple alternators chain of claims 5, and 6, wherein the alternator's sprocket/rod, comprises:
a secondary sprocket/and chain system wherein there is a connection with all alternators;
a first, main sprocket wherein this system is needed to rotate the second system;
a set of end bearings, wherein smooth rotation is possible, with lubrication as a requirement.

8. The electric vehicle drive mechanism for driving multiple alternators chain of claim 1, wherein a complete, rear charging system is illustrated witch comprises:
a rubber, drive wheel, wherein with the wheel's rotation, starts the mechanical energy at that point 1;
a square, telescoping, drive wherein the mechanical energy is advanced forward in the system 11;
a triangular like, telescoping drive support system, wherein stable support is afforded at this point in the system;
a first, main sprocket, wherein that mechanical energy is transferred to the rear/inner end of the telescoping drive system;
a first, main chain, wherein a physical connection is made, with the alternator's secondary sprocket/rod system;
a five alternator bracket/plate, wherein the efficient configuration of said five alternators, allows the smooth rotation of the five alternators on the platform;
a five grouping of alternators, wherein through the rotation of the drive wheel, the alternators charge the battery assigned to that individual alternator;
a rubber, sound/vibration material, wherein a rear passenger will not experience a high level of sound, or vibration 56 A, and 56 B;
a five alternator sound/vibration reduction, chain guard, wherein a further reduction of sound, and vibration is experienced by the rear passengers.

9. The electric vehicle drive mechanism for driving multiple alternators chain of claim 8 wherein a four alternator bracket/plate affording stable mounting of said set of four alternators, affording smooth rotation of the alternators comprises:
a bracket/plate, wherein the four alternators can be fixed with mobility to the platform;
a group of holes, wherein the alternator can be fixed at one mounting point, and have a slide, elongated, hole, to adjust the chain;
a sound/vibration apparatus, wherein sound/vibration is reduced for the rear seat passengers;
a battery grouping to the rear of the platform, wherein both the five and four alternator configurations charge their assigned batteries.

10. The electric vehicle drive mechanism for driving multiple alternators chain of claims 8, and 9, wherein the rear alternator configuration comprises:
a end or rear of the telescoping drive shaft, wherein mechanical energy is transferred to the first, main sprocket;
a first, main chain, wherein a physical connection is made with the alternator's sprocket/rod;
a second sprocket/rod system, wherein a physical connection is made with the alternator's sprocket, driven by the main, first, sprocket, on the alternator's second sprocket/rod;
a end bearing configuration, wherein smooth rotation is possible, with a lubrication;
a lower, center, bearing housing, support apparatus, wherein the inner most bearings on the alternator's sprocket/rod affording base support;
a sound/vibration reduction material, wherein the rear seat experiences a reduction in sound, as well as vibration;
a rear trunk, alternator configuration wherein twenty three alternators will be fitted.

11. The electric vehicle drive mechanism for driving multiple alternators chain of claim 10, wherein the twenty three alternators comprises:
a illustration of the alternator's designations, as it relates to their matching Lithium ion batteries.

12. The electric vehicle drive mechanism for driving multiple alternators chain of claim 10, wherein the rear, secondary, sprocket/rod apparatus comprises:
a base, wherein it is insulated, having four bolts/nuts, fixed to the platform floor, affording lower base stability;
a rubber insulation material, wherein said insulation reduces sound/vibration as it relates to the platform's rear comfort level;
a apparatus having a body, wherein it has a 90 degree angle, at the lower 55 percent of the apparatus's body;
a upper 45 percent of the apparatus's body, wherein it is configured at a 135 degree angle, of the lower body's 90 degree angle center axis;
a single, right, forward, 60 degree angle base, wherein front to back movement is canceled;
a pair of rear, 130 degree angle bases wherein additional forward, reverse stability is afforded;
a set of four horizontal braces, wherein side to side rigidity, as a result of tying both vertical bodies together, further fixing the apparatus body in place, to the platform;
a ball bearing housing, wherein this bearing housing is configured at the highest point of the apparatus, so as to intercept the alternator's sprocket/rod, in addition configured with the upper body forward, so as to not interfere with the alternators on their bracket/plate, specifically #18, and #23;
a lubrication method, wherein a grease nipple is configured in the bearing housing, affording lubrication.

13. The electric vehicle drive mechanism for driving multiple alternators chain of claim 12, wherein the rear, alternator's sprocket/rod support apparatus further comprises:
a rear perspective of FIG. 12 wherein two, rear 130 degree angle, lower, braces are extending from the base to the upper 55 percent of the total body;
a bearing housing, wherein it is configured at the highest point of the apparatus, allowing alternator clearance, two side, separated, in addition to excepting the alternator's sprockets/rods;
a set of four horizontal braces, wherein the braces are configured at the lower 10 percent of the base, front and back, in addition at a 60 percent, from the base, front and back, affording side to side rigidity;
a set of two anchor bolts/nuts wherein a rear perspective of the rear bolts/nuts, illustrate the distance between the two anchor bolts/nuts, as it relates to stability of the apparatus;
a lubrication is possible, wherein the apparatus has a greasing nipple for both sides of the apparatus, affording smooth rotation of the bearings, as well as the alternator's sprocket/rod;
a alternator, sprocket/rod system, wherein this secondary driving system rotate the alternators solely.

14. The electric vehicle drive mechanism for driving multiple alternators chain of claim 8, wherein the platform's wiring configuration is illustrated having power coming from all thirty two, motor, Lithium ion batteries comprises:
a direct battery to motor connection, wherein power lines are leading from the batteries, on route to the motor;
a fuse system, wherein the system's power has already passed through the first fuse system, arriving at the second, high voltage fuse brake system, having passed through the second high voltage fuse brake, moving on;
a voltage sending system, wherein the ability to control the voltage is afforded, by way of a “OFF, ON, ACC, and LOCK” control switch;
a receiving, motor unit, wherein the system's energy can be transferred to the motor smoothly, with on obstructions.

15. The electric vehicle drive mechanism for driving multiple alternators chain of claim 14, wherein a individual, battery charging system comprises:
a individual battery charging system, wherein a 120 VAC charger is configured to charge one battery at a time, utilizing a rod like 12 VOLT, delivery apparatus, to a receiver;
a female power receiving board, wherein the system allows the batteries to receive power through this energy transfer, (NOTE, NO POWER/ENERGY, IS NEEDED TO REPLENESH POWER/ENERGY CONSUMED BY THE MOTOR!);
a voltage indicator light, wherein the light will go red, when a battery is low, or has on voltage.

16. The electric vehicle drive mechanism for driving multiple alternators chain of claims 3, 10, and 11, wherein all alternators have a matching Lithium ion battery, charged in a standard method.

17. The electric vehicle drive mechanism for driving multiple alternators chain of claims 15 and 16, wherein a standard 12 VOLT Lithium ion battery is being recharged by a custom 12 VOLT adaptor, ONLY WHEN NEEDED, comprises:
a 1 A alternator is charging a 1 B Lithium ion battery, wherein the batteries will stay charged, by the same method as a conventional, alternator to battery relationship;
a standard fuse brake, wherein the system's electrics are protected;
a battery grouping, wherein thirty two batteries are illustrated, to serve as a power source for the motor, as well as a single 12 VOLT Lithium ion battery for the vehicle's normal, non motor functions;
a red low voltage light, wherein if for some reason a battery losses power, the low voltage, red light, will eliminate.

18. The electric vehicle drive mechanism for driving multiple alternators chain of claims 8, and 10, wherein the system has only air cooling for all the components in the rear of the platform, the alternators, and lower, rear, Lithium ion batteries, air will enter at this point, flow over the Lithium ion batteries, than exit to the most rear portion of the platform, by way of rear vents, comprises:
a door air scoop, wherein a fabricated, metal air scoop is configured on the rear door;
a first, forward, vent, wherein air is received ahead of the alternators;
a first, vent, air lock door, wherein rain/moisture can be kept from the electrical energy production system;
a door casing vents, wherein air can be transferred from that more forward position, as it relates to air;
a air director, wherein the air captured, can be directed to the area most needed;
a rear panel, front void, wherein the opening is configured for maximum air flow to all rear components.
